(19) United States
(12) Patent Application Publication
(10) Pub. No.: US 2022/0169486 A1
(43) Pub. Date: Jun. 2, 2022

(54) SIDE WIND TONGUE JACK

(71) Applicant: Lippert Components, Inc., Elkhart, IN (US)

(72) Inventors: Samuel Evans, Granger, IN (US); Evan Whitney, Buchanan, MI (US); Victor Ortiz, Elkhart, IN (US)

(21) Appl. No.: 17/537,606

(22) Filed: Nov. 30, 2021

Related U.S. Application Data
(60) Provisional application No. 63/119,086, filed on Nov. 30, 2020.

(51) Int. Cl. B66F 3/16; B60D 1/66

(52) U.S. Cl. CPC B66F 3/16; B60D 1/66

(57) ABSTRACT

A tongue jack includes a drive screw and a lifting assembly coupled with the drive screw. A first bevel gear is secured to the drive screw with a rotation axis aligned with a rotation axis of the drive screw. A second bevel gear engages the first bevel gear with a rotation axis perpendicular to the rotation axis of the first bevel gear. A drive head is connected to the second bevel gear, and a coupler is selectively engageable with and disengageable from the drive head. A handle assembly may be connected to the coupler that is rotatable about the rotation axis of the second bevel gear, where the handle assembly includes a crank handle spaced from and parallel to the rotation axis of the second bevel gear.

### CROSS-REFERENCES TO RELATED APPLICATIONS

This application claims the benefit of U.S. Provisional Patent Application Ser. No. 63/119,086, filed Nov. 30, 2020, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to a tongue jack for a trailer and, more particularly, to a side wind tongue jack with a gear arrangement for a side mounted crank and handle.

A trailer may be provided with a tongue jack to support the tongue of a trailer when the trailer is not hitched to a tow vehicle and to raise and lower the tongue of the trailer to facilitate hitching and unhitching of the trailer to and from the tow vehicle. Tongue jacks come in both power-operated and manually-operated forms. Manually-operated tongue jacks have the advantages of being relatively low in cost, weight, and complexity, but they can require considerable effort to operate. Power-operated tongue jacks have the advantage of being relatively easy to operate, but they are more costly and heavy, and they require a power source to be operable.

One such power source is the tow vehicle's electrical system, which may provide power to the jack through the trailer's brake system and lighting system electrical harness. Another such power source is a trailer-mounted battery. The tow vehicle's electrical system may be a lower cost alternative than a trailer-mounted battery, but reliance on the tow vehicle's electrical system to power the jack requires that the tow vehicle be present and that its electrical system be connected to the trailer, which may not always be possible or convenient. Reliance on a trailer-mounted battery may be more convenient in some regards, but such a battery adds cost, adds weight to and occupies space on the trailer, and must be properly maintained. In any event, lack of or failure of a suitable power supply may render a power-operated jack inoperable.

A power-operated jack may be provided with a manual override to maintain operability of the jack in the absence of a power source. Such a manual override, however, typically is provided and intended as a secondary means for operating the power-operated jack, and it may add even more weight, cost, and complexity to the jack.

### SUMMARY

The tongue jack of the described embodiments is configured for manual operation using a side-mounted handle or alternatively using an external actuator. The tongue jack includes a bevel gear arrangement to transfer the torque applied via the side-mounted handle to a vertically-mounted lifting assembly. The side-mounted handle or crank is part of a handle assembly that is rotatable about the rotation axis of one of the bevel gears. The handle assembly may be pivotable between an engaged position in which the handle assembly acts on the bevel gears, and a disengaged position in which the handle assembly is detached from the bevel gears.

In an exemplary embodiment, a tongue jack includes a fixed tube, a lifting tube cooperable with the fixed tube and axially displaceable and rotationally fixed relative to the fixed tube, and a drive screw threadedly engaging the lifting tube such that rotation of the drive screw effects axial displacement of the lifting tube relative to the fixed tube. A first bevel gear is secured to the drive screw, and a rotation axis of the first bevel gear is aligned with a rotation axis of the drive screw. A second bevel gear engages the first bevel gear, and a rotation axis of the second bevel gear is perpendicular to the rotation axis of the first bevel gear. The tongue jack also includes a drive head connected to the second bevel gear and a coupler selectively engageable with and disengageable from the drive head.

The tongue jack may additionally include a handle assembly connected to the coupler that is pivotable between an engaged position in which the handle assembly displaces the coupler into engagement with the drive head and a disengaged position in which the handle assembly displaces the coupler out of engagement with the drive head. An enclosure may surround the first and second bevel gears. The handle assembly may include parallel flanges secured on opposite sides of the coupler, and each of the parallel flanges may include a cam surface at distal ends thereof acting against the enclosure. The parallel flanges may be connected to the coupler at a position offset from a pivot axis of the handle assembly. The handle assembly may include a crank handle connected adjacent proximal ends of the parallel flanges. The crank handle may be parallel to the rotation axis of the second bevel gear when the handle assembly is in the engaged position.

With the handle assembly including a crank handle, the crank handle may be parallel to the rotation axis of the second bevel gear when the handle assembly is in the engaged position.

The handle assembly may be rotatable around the rotation axis of the second bevel gear in the engaged position.

In another exemplary embodiment, a tongue jack includes a drive screw and a lifting assembly coupled with the drive screw. The lifting assembly is raised by rotation of the drive screw in a first direction, and the lifting assembly is lowered by rotation of the drive screw in a second direction. A first bevel gear is secured to the drive screw, and a rotation axis of the first bevel gear is aligned with a rotation axis of the drive screw. A second bevel gear engages the first bevel gear, and a rotation axis of the second bevel gear is perpendicular to the rotation axis of the first bevel gear. A drive head is connected to the second bevel gear, and a coupler is selectively engageable with and disengageable from the drive head. A handle assembly connected to the coupler and rotatable about the rotation axis of the second bevel gear includes a crank handle spaced from and parallel to the rotation axis of the second bevel gear.

### BRIEF DESCRIPTION OF THE DRAWINGS

These and other aspects and advantages will be described in detail with reference to the accompanying drawings, in which:

FIG. 1 is a perspective view of the side wind tongue jack according to the described embodiments;

FIGS. 2 and 3 show side and front views of the tongue jack;

FIG. 4 is a cross-sectional view along line A-A in FIG. 3;

FIG. 5 shows details of the handle assembly and gear train;

FIG. 6 shows the coupler in an engaged position for activation of the tongue jack using the side-mounted crank; and

FIG. 7 shows the coupler in a disengaged position.

### DETAILED DESCRIPTION

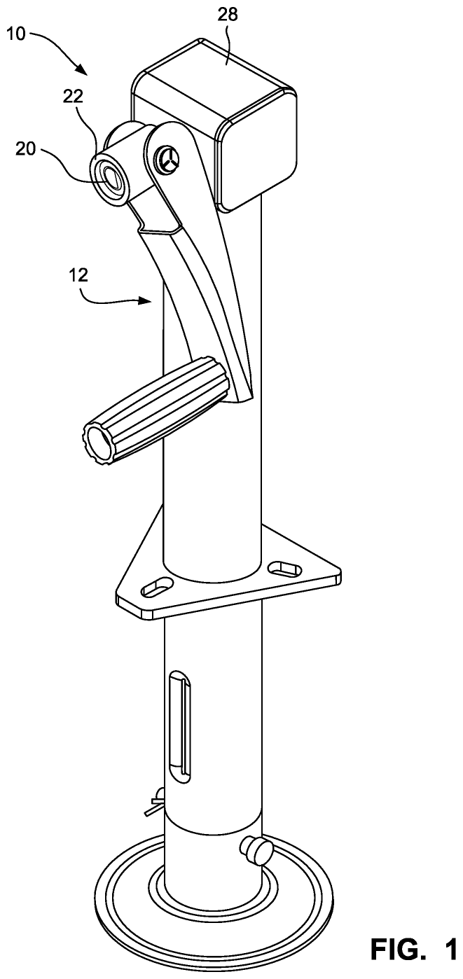

FIG. 1 is a perspective view of a trailer tongue jack 10 according to the described embodiments. The trailer tongue jack 10 includes a side-mounted handle assembly 12 that is pivotable between an engaged position and a disengaged position and is rotatable in the engaged position to raise and lower the tongue jack 10.

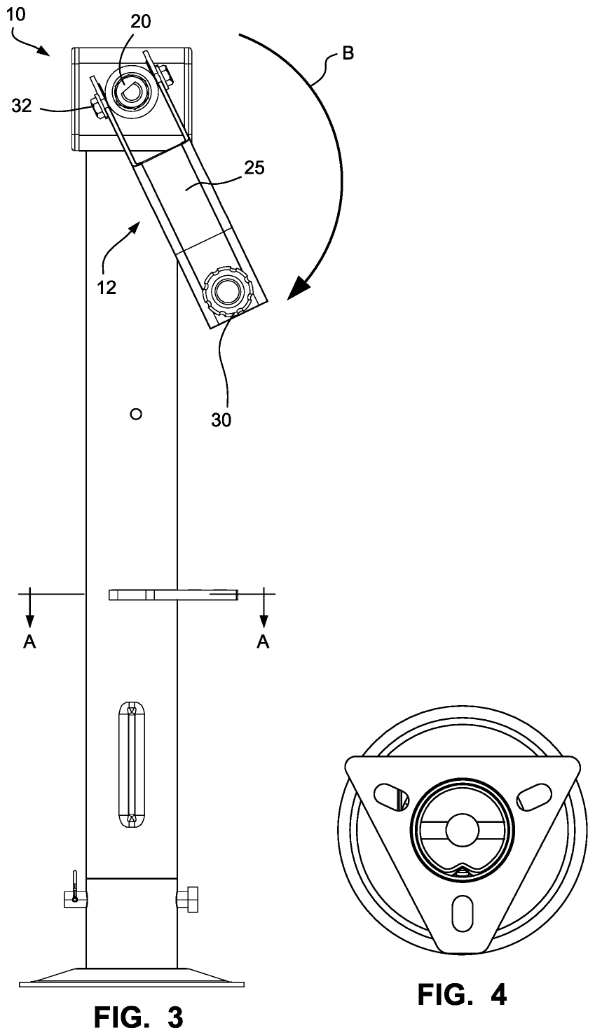

The structure that effects raising and lowering of the tongue jack 10 is known, and any suitable lifting structure or lifting assembly associated with a drive screw may be utilized. In an exemplary construction, the tongue jack 10 includes concentric tubes in the form of a fixed tube and a lifting tube cooperable with a fixed tube. See FIG. 4. The lifting tube may be axially displaceable and rotationally fixed relative to the fixed tube. A drive screw 14 may be threadedly engaged with the lifting tube such that rotation of the drive screw effects axial displacement of the lifting tube relative to the fixed tube. Details of this and other exemplary lifting structure are described in U.S. Pat. No. 10,343,654, the contents of which are hereby incorporated by reference.

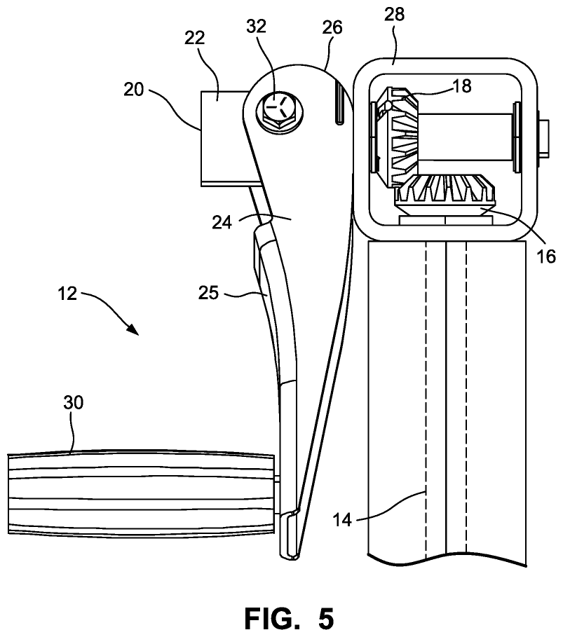

With the side-mounted handle assembly 12, rotation of the handle assembly 12 is transferred from a horizontal rotation axis to a vertical rotation axis. With reference to FIG. 5, a first bevel gear 16 is secured to the drive screw 14. As shown, a rotation axis of the first bevel gear 16 is aligned with a rotational axis of the drive screw 14. In the exemplary embodiment shown in FIG. 5, the rotation axis of the first bevel gear 16 and the rotation axis of the drive screw 14 are oriented vertically. A second bevel gear 18 engages the first bevel gear 16, and a rotation axis of the second bevel gear 18 is essentially perpendicular to the rotation axis of the first bevel gear 16. A drive head 20 is connected to the second bevel gear 18. As such, rotation of the drive head 20 effects rotation of the second bevel gear 18, which in turn effects rotation of the first bevel gear 16, which then effects rotation of the drive screw 14.

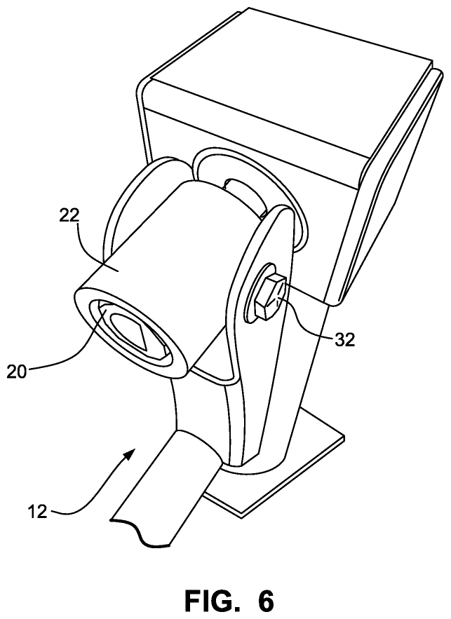

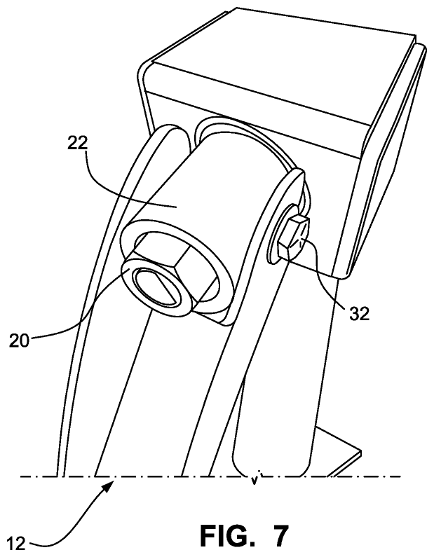

A coupler 22 is selectively engageable with and disengageable from the drive head 20. In the engaged position shown in FIG. 6, the coupler 22 is engaged with the drive head 20, and rotation of the coupler 22 via the handle assembly 12 effects rotation of the drive head 20. In the disengaged position shown in FIG. 7, the coupler 22 is out of engagement with the drive head 20, and rotation of the coupler 22 via the handle assembly 12 will have no effect on the drive head 20. In the disengaged position, the drive head 20 may be engaged by an external tool or other mechanism to effect rotation of the drive head 20.

The handle assembly 12 includes parallel flanges 24 secured on opposite sides of the coupler 22. A connecting plate 25 is connected between the parallel flanges 24. Each of the parallel flanges 24 includes a cam surface 26 at distal ends thereof. The cam surfaces 26 act against an enclosure 28 that surrounds the first and second bevel gears 16, 18.

A crank handle 30 is connected adjacent proximal ends of the parallel flanges 24 and is coupled rotatably with the connecting plate 25. In some embodiments, the crank handle 30 is parallel to the rotation axis of the second bevel gear 18 when the handle assembly 12 is in the engaged position. As shown, the crank handle 30 is spaced from and parallel to the rotation axis of the second bevel gear 18.

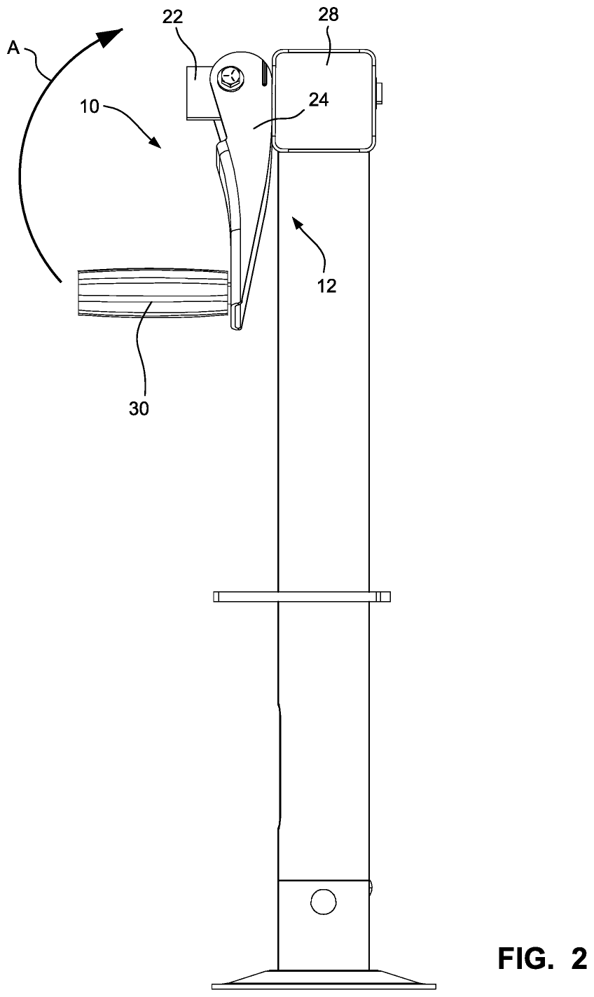

A pair of connectors 32 secure the parallel flanges 24 to the coupler 22 to secure the entire handle assembly 12 to the coupler 22. The parallel flanges 24 are connected to the coupler 22 via the connectors 32 at a position offset from a pivot axis of the handle assembly 12. As such, as the handle assembly 12 is pivoted in the direction of arrow A in FIG. 2, the cam surfaces 26 act against the enclosure 28 to displace the coupler 22 from the engaged position shown in FIG. 6 to the disengaged position shown in FIG. 7.

In use, with the handle assembly in the engaged position (FIG. 6), the handle assembly 12 is rotatable via the crank handle 30 around the rotation axis of the second bevel gear 18. See arrow B in FIG. 3. Rotation of the handle assembly 12 in one direction serves to raise the tongue jack 10, whereas rotation of the handle assembly 12 in an opposite direction serves to lower the tongue jack 10. If it is subsequently desired to use an alternative tool to drive the drive head 20, the handle assembly 12 can be pivoted in the direction of arrow A in FIG. 2 to displace the coupler 22 to the disengaged position shown in FIG. 7. In this position, the drive head 20 is exposed and accessible by an exterior or alternative tool.

The tongue jack of the described embodiments includes a side-mounted crank handle that facilitates manual operation of the tongue jack. Additionally, the handle assembly may be disengaged from the drive head so that the drive head can be accessed by an external actuator.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A tongue jack comprising:
a fixed tube;
a lifting tube cooperable with the fixed tube, the lifting tube being axially displaceable and rotationally fixed relative to the fixed tube;
a drive screw threadedly engaging the lifting tube such that rotation of the drive screw effects axial displacement of the lifting tube relative to the fixed tube;
a first bevel gear secured to the drive screw, wherein a rotation axis of the first bevel gear is aligned with a rotation axis of the drive screw;
a second bevel gear engaging the first bevel gear, wherein a rotation axis of the second bevel gear is perpendicular to the rotation axis of the first bevel gear;
a drive head connected to the second bevel gear; and
a coupler selectively engageable with and disengageable from the drive head.

2. A tongue jack according to claim 1, further comprising a handle assembly connected to the coupler, the handle assembly being pivotable between an engaged position in which the handle assembly displaces the coupler into engagement with the drive head and a disengaged position in which the handle assembly displaces the coupler out of engagement with the drive head.

3. A tongue jack according to claim 2, further comprising an enclosure surrounding the first and second bevel gears.

4. A tongue jack according to claim 3, wherein the handle assembly comprises parallel flanges secured on opposite sides of the coupler, and wherein each of the parallel flanges comprises a cam surface at distal ends thereof acting against the enclosure.

5. A tongue jack according to claim 4, wherein the parallel flanges are connected to the coupler at a position offset from a pivot axis of the handle assembly.

6. A tongue jack according to claim 4, wherein the handle assembly further comprises a crank handle connected adjacent proximal ends of the parallel flanges.

7. A tongue jack according to claim 6, wherein the crank handle is parallel to the rotation axis of the second bevel gear when the handle assembly is in the engaged position.

8. A tongue jack according to claim 2, wherein the handle assembly further comprises a crank handle, the crank handle being parallel to the rotation axis of the second bevel gear when the handle assembly is in the engaged position.

9. A tongue jack according to claim 2, wherein the handle assembly is rotatable around the rotation axis of the second bevel gear in the engaged position.

10. A tongue jack according to claim 1, further comprising a handle assembly connected to the coupler and rotatable about the rotation axis of the second bevel gear, the handle assembly including a crank handle spaced from and parallel to the rotation axis of the second bevel gear.

11. A tongue jack comprising:
a drive screw;
a lifting assembly coupled with the drive screw, the lifting assembly being raised by rotation of the drive screw in a first direction, and the lifting assembly being lowered by rotation of the drive screw in a second direction;
a first bevel gear secured to the drive screw, wherein a rotation axis of the first bevel gear is aligned with a rotation axis of the drive screw;
a second bevel gear engaging the first bevel gear, wherein a rotation axis of the second bevel gear is perpendicular to the rotation axis of the first bevel gear;
a drive head connected to the second bevel gear;
a coupler selectively engageable with and disengageable from the drive head; and
a handle assembly connected to the coupler and rotatable about the rotation axis of the second bevel gear, the handle assembly including a crank handle spaced from and parallel to the rotation axis of the second bevel gear.

12. A tongue jack according to claim 11, wherein the handle assembly is pivotable between an engaged position in which the handle assembly displaces the coupler into engagement with the drive head and a disengaged position in which the handle assembly displaces the coupler out of engagement with the drive head.

13. A tongue jack according to claim 12, wherein the handle assembly is connected to the coupler at a position offset from a pivot axis of the handle assembly.

14. A tongue jack according to claim 11, further comprising an enclosure surrounding the first and second bevel gears.

15. A tongue jack according to claim 14, wherein the handle assembly comprises parallel flanges secured on opposite sides of the coupler, and wherein each of the parallel flanges comprises a cam surface at distal ends thereof acting against the enclosure.

16. A tongue jack according to claim 15, wherein the parallel flanges are connected to the coupler at a position offset from a pivot axis of the handle assembly.

17. A tongue jack according to claim 15, further comprising a connecting plate connected between the parallel flanges, wherein the crank handle is coupled with the connecting plate.
